(19) United States
(12) Patent Application Publication
(10) Pub. No.: US 2011/0215498 A1
(43) Pub. Date: Sep. 8, 2011

(54) MOULDED THERMOPLASTIC ARTICLES AND PROCESS TO MAKE THEM

(75) Inventor: Fuquan Zeng, Cowling (GB)

(73) Assignee: COLORMATRIX EUROPE LIMITED, Knowsley (GB)

(21) Appl. No.: 13/105,922

(22) Filed: May 12, 2011

Related U.S. Application Data
(63) Continuation of application No. 10/530,984, filed on Sep. 27, 2005.

(30) Foreign Application Priority Data
Oct. 12, 2002 (GB) 0223778.2

(51) Int. Cl. D06P 3/54; D01F 1/06; B05D 1/18

(52) U.S. Cl. 264/78; 8/512; 427/430.1

(57) ABSTRACT

This invention relates to moulded polyethylene terephthalate articles and to a process for making them. In one of its aspects the invention relates to a process in which colour or additive is applied to a moulded polyethylene terephthalate article in a post-moulding step and to articles produced by such a process, in particular to a process for manufacturing a coloured polyethylene terephthalate container or container preform comprising providing a container or container preform of a polyethylene terephthalate, providing a colouration zone containing as a solution or dispersion in a liquid medium one or more colourants having a chemical affinity for polyethylene terephthalate of the container or container preform, and in the colouration zone contacting the container or container preform with the one or more colourants in the liquid medium for a period of time and under conditions effective to cause at least a portion of the one or more colourants to migrate from the liquid medium and bind to the container or container preform.

### CROSS-REFERENCES TO RELATED APPLICATIONS

This application is a continuation of U.S. National Phase Application Serial No. 10/530,984, entitled “Moulded Thermoplastic Articles And Process To Make Them” which entered the National Phase on Sep. 27, 2005, based on International Application No. PCT/GB2003/004387 entitled “Moulded Thermoplastic Articles And Process To Make Them”, filed Oct. 10, 2003, which claims priority to GB 0223778.2 filed Oct. 12, 2002, all of which are hereby incorporated by reference.

### BACKGROUND OF THE INVENTION

This invention relates to moulded thermoplastic articles and to a process for making them, in particular to moulded thermoplastic articles provided with a colourant or additive and to a process for the manufacture of such articles. In one of its aspects the invention relates to a process in which colour or additive is applied to a moulded thermoplastic article in a post-moulding step and to articles produced by such a process.

Polyethylene terephthalate is used on a large scale for the manufacture of food packages such as bottles. Such bottles are widely utilised for packaging of beverages, such as carbonated soft drinks, beer, or mineral water. Whilst some beverage bottlers prefer clear non-pigmented bottles, others prefer coloured bottles. Particularly in the case of bottles intended for holding carbonated drinks, a sandwich construction is used in which nylon or an ethylene-vinyl alcohol resin is incorporated in a multi-layer preform with polyethylene terephthalate in order to improve the gas barrier properties of the bottles. It has also been proposed, for the same purpose, to admix a polyamide with the polyethylene terephthalate since the presence of the polyamide provides gas barrier properties.

It is also often desirable to include in the bottle or other package one or more colourants or additives such as UV filters, oxygen absorbers, antimicrobial agents, antioxidants, light stabilizers, optical brighteners, processing stabilizers, flame retardants and the like.

The technique commonly used to manufacture bottles from moulding compositions comprising polyethylene terephthalate generally involves a two stage process. In the first stage granules of the moulding composition are injection moulded to make a preform. In the second stage the preform is blow moulded to the desired shape.

Similar processing steps are used in the manufacture of bottles and other packages from other polyesters and from other thermoplastic materials generally.

In such a process the polyethylene terephthalate is typically post-condensed and has a molecular weight in the region of about 25,000 to 30,000. However, it has also been proposed to use a fibre grade polyethylene terephthalate, which is cheaper but is non-post-condensed, with a lower molecular weight in the region of about 20,000. It has further been suggested to use copolyesters of polyethylene terephthalate which contain repeat units from at least 85 mole % terephthalic acid and at least 85 mole % of ethylene glycol. Dicarboxylic acids which can be included, along with terephthalic acid, are exemplified by phthalic acid, isophthalic acid, naphthalene-2-6-dicarboxylic acid, cyclohexane dicarboxylic acid, cyclohexanediacetic acid, diphenyl-4,4′-dicarboxylic acid, succinic acid, glutaric acid, adipic acid, azelaic acid, and sebacic acid. Other diols which may be incorporated in the copolyesters, in addition to ethylene glycol, include diethylene glycol, triethylene glycol, 1,4-cyclohexanedimethanol, propane-1,3-diol, butane-1,4-diol, pentane-1,5-diol, hexane-1,6-diol, 3-methylpentane-2,4-diol, 2-methylpentane-1,4-diol, 2,2,4-trimethylpentane-1,3-diol, 2-ethylhexane-1,3-diol, 2,2-diethylpropane-1,3-diol, hexane-1,3-diol, 1,4-di-(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane and 2,2-bis-(4-hydroxypropoxyphenyl)-propane. In this specification the term “polyethylene terephthalate” includes not only polyethylene terephthalate but also such copolyesters.

If the eventual bottle is to be coloured, then it is conventional to admix a colourant or colourants with the polyethylene terephthalate granules charged to the hopper of the injection moulding machine used to make the bottle preform. For this purpose the colourant or mixture of colourants can be added as a solid concentrate or in powder form or as a dispersion in a liquid carrier. Additives may also be added to the thermoplastic moulding composition at or around the same time, i.e. before moulding of the composition.

One important property of thermoplastic materials is their crystallinity. Crystallinity has a particular impact on both the light transparency and the tensile properties of the polymer. Crystallinity can be measured in numerous ways, for example volume change, heat capacity, enthalpy change, X-ray scattering, infra-red and Raman spectroscopy. Often for practical purposes the degree of crystallinity of a polymer, if pronounced or present over a wide area, can be judged by visual observation. However, it can be difficult visually to observe small areas of local crystallinity, particularly in a finished polymer product which is opaque.

There is a need to provide a means for imparting colour, or imparting desirable additive properties, to a thermoplastic moulded article after, rather than before, moulding of the article. This will allow the manufacturer to proceed with the moulding of the article before necessarily knowing what the final colour, or additive profile, of the article should be. In this way a bottle manufacturer may proceed with a large part of the bottle production process before finishing the product by the addition of one or more colours or additives. Orders for differently coloured products of the same shape and size, or for same shape and size products with different additive profiles can therefore be met more expeditiously than has hitherto been the case. There is also a need to provide a convenient method of assessing the degree of crystallinity of a thermoplastic moulded article which does not rely on difficult visual inspection or time-consuming analytical tests.

It would also be advantageous to provide a means for colouring, or imparting additives to, a moulded article without incorporating unnecessarily any coloured or additive component in the moulding stages, for example in the injection moulding machine, which would otherwise necessitate cleaning of the injection moulding machine, for example, between different runs of products which are the same in respects other than their colour and/or additive profile.

There is also a need to provide moulded articles with more distinct and/or controllable colour or additive definition than has hitherto been the case. For example, it would be desirable to manufacture articles with decorative patterns of different colours.

It would also be desirable to provide a process for manufacturing a coloured moulded article, or a moulded article with a desirable additive profile, which utilises a lower quantity of colourant, or additive, to achieve an equivalent aesthetic or functional effect than has hitherto been the case.

### BRIEF SUMMARY OF THE INVENTION

According to the present invention there is provided a process for manufacturing a coloured thermoplastic moulded article comprising providing a moulded article of a thermoplastic material, providing a colouration zone containing as a solution or dispersion in a liquid medium one or more colourants having a chemical affinity for the thermoplastic material of the moulded article, and in the colouration zone contacting the moulded article with the one or more colourants in the liquid medium for a period of time and under conditions effective to cause at least a portion of the one or more colourants to migrate from the liquid medium and bind to the moulded article.

The process of the invention may comprise providing a thermoplastic moulding composition and subjecting said thermoplastic moulding composition to a moulding step thereby to form the moulded article which is then contacted with the one or more colourants in the colouration zone.

Thus, the process of the invention may comprise providing a thermoplastic moulding composition, subjecting said thermoplastic moulding composition to a moulding step thereby to form a moulded article, and contacting the moulded article with a colourant having a chemical affinity for the moulded article for a period of time and under conditions effective to cause binding of the colourant to at least the surface of the moulded article which contacts the colourant.

Also provided in accordance with the invention is a process for manufacturing a thermoplastic moulded article having additive-imparted functionality comprising providing a moulded article of a thermoplastic material, providing an additive impartation zone containing as a solution or dispersion in a liquid medium one or more additives having a chemical affinity for the thermoplastic material of the moulded article, and in the additive impartation zone contacting the moulded article with the one or more additives in the liquid medium for a period of time and under conditions effective to cause at least a portion of the one or more additives to migrate from the liquid medium and bind to the moulded article.

The process of the invention may therefore comprise providing a thermoplastic moulding composition, subjecting said thermoplastic moulding composition to a moulding step thereby to form a moulded article, and contacting the moulded article with an additive having a chemical affinity for the moulded article for a period of time and under conditions effective to cause binding of the additive to at least the surface of the moulded article which contacts the additive.

The additive may be any material which has a chemical affinity for the moulded article and which imparts a desirable property to the moulded article. Examples of types of additive include UV filters, oxygen absorbers, antimicrobial agents, antioxidants, light stabilizers, optical brighteners, processing stabilizers, flame retardants and the like.

In the process of the invention it may also be desirable to contact the moulded article with a mixture of two or more colourants, with a mixture of two or more additives, or with a mixture of one or more colourants with one or more additives. Alternatively, or as well, it may be desirable to contact the moulded article sequentially with a number of different colourants and/or additives. It is also envisaged that the application of a particular colour and/or additive may be targeted to a specific region of the moulded article, perhaps to provide a pleasing aesthetic effect or to enhance functionality provided by an additive in that particular region of the moulded article. By way of example, moulded articles with decorative stripes of different colours may conveniently be produced according to the process of the invention by subjecting the moulded article to a number of sequential colouration steps.

It may be desirable prior to contacting the moulded article with a colourant or additive to coat one or more regions of the moulded article with a barrier material (such as a waxy film for example) to prevent binding of the colourant or additive to the moulded article in the region (s) coated with the barrier material during the subsequent colourant/additive contacting step. In this way it would be possible, for example, to obtain more intricate patterns of colour on the finished moulded article.

In a preferred process according to the invention, it is not necessary to pre-treat the material of the molded article prior to colouration or additive impartation.

In the process of the invention it is important that the colourant or additive has a chemical affinity for the thermoplastic material used to make the moulded article. Such chemical affinity may be provided by means, for example, of ionic, covalent or hydrogen bonding. In this regard, different types of colourants and additives will be suitable for different types of thermoplastic material. If the thermoplastic material of the moulded article is predominantly polyethylene terephthalate or another polyester then the colourant may suitably be a disperse dye. However, if the thermoplastic material of the moulded article is nylon then the colourant may suitably be an acid dye, for example. One example of a suitable acid dye is Dyacid Turquoise Blue V_{B}.

Suitable disperse dyes include anthraquinone, indanthrone, monoazo, diazo, mithine, quinophthalone, perinone, naphthalidimide and thioindigo dyes. Examples of disperse dyes which may be suitable for use as colourants in the process of the invention include, but are not limited to, the Dispersol™ dyes available from Chemrez Incorporated at www.chemrez.com, the Terasil™ and Teratop™ dyes available from Ciba Specialties Chemicals Inc. at www.cibasc.com and the Palegal™ dyes available from BASF AG at www.basf.com. Disperse dyes are also commercially available from a variety of other suppliers including Bayer AG, notably their Dystar™ range.

Acid dyes, for use in the process of the invention when the thermoplastic material of the moulded article comprises nylon, are also available from these suppliers. Examples of suitable acid dyes include CI acid violet 90 (Dyalan Bordeux S-B 200% from Albion Colours) and CI acidEL17 (Dyacid yellow 2G from Albion Colours). Nylon under acidic conditions generally binds to dyes through the amino end group of the polymer. Under neutral dyeing conditions non-specific hydrophobic interactions and van der Waals forces make a considerable contribution, reinforcing the electrostatic binding between nylon and the acid dye.

The colourant composition may contain a single dye or a mixture of dyes depending upon the desired colouration of the article. For example, in order to produce an amber coloured bottle there may be required a mixture of a red dye, a yellow dye and a blue dye.

Examples of additives which may be suitable for use in the process of the invention include, but are not limited to, UV absorbers such as benzophenones, diphenyl acrylates, cinnamates and sterically hindered amines (HALS).

Disperse dyes have been used for many years as colourants in the textile industry and have been used to colour polyester fibres, for example. However, it has not hitherto been known to impart colour to a moulded article by directly contacting said article with a colourant such as a disperse dye for a period of time and under conditions effective to cause binding of the colourant with the contacted surface of the moulded article. Nor has it hitherto been recognised that functional additives could be applied to moulded articles in this way.

The conditions effective to cause binding of the colourant or additive to the thermoplastic material of the moulded article will vary depending on a number of factors, including the intended end result (i.e. the depth of colour required, for example) as well as the type of colourant or additive and the type of thermoplastic material being used.

In the process of the invention the colourant or additive is preferably provided as a solution or dispersion of a dye or additive in an aqueous or organic solvent or dispersal medium. It is preferred to use an aqueous based dispersal medium, such as water, for reasons of cost, environmental suitability, availability and the like. Thus, in one preferred process according to the invention the colourant is provided as a dispersion of a disperse dye in water. In another preferred process according to the invention the additive is provided as a dispersal of the additive in water.

The colourant or additive is preferably provided as a solution or dispersion in a suitable vessel, such as a dye bath for example, into which the moulded article can be dipped to contact the external surface of the article with the colourant or additive.

The concentration of the dye in the solution or dispersal medium may be selected according to the amount of colour required to be imparted to the moulded article, the residence time for which the moulded article is in contact with the colourant and other conditions, both physical and chemical, prevailing as the contact is made. Usually, the concentration of the dye will be from about 0.01% to about 15% by weight of the moulded article, preferably from about 0.05 to about 10% by weight of the moulded article, more preferably from about 0.1% to about 5% by weight of the moulded article.

The concentration of the additive in the solution or dispersal medium may be selected according to the amount of additive required to be imparted to the moulded article, the residence time for which the moulded article is in contact with the additive and other conditions, both physical and chemical, prevailing as the contact is made. Usually, the concentration of the additive will be from about 0.001% to about 10% by weight, preferably from about 0.005 to about 5% by weight, more preferably from about 0.01% to about 1% by weight.

The residence time for which the moulded article is in contact with the colourant or additive in the process of the invention may be selected according to a number of considerations, including the concentration of colourant or additive as mentioned above, the depth of colour, or level of functionality imparted by the additive, required in the moulded article and other conditions prevailing as the contact is made. Usually, the residence time will be from about 10 seconds to about 15 minutes, preferably from about 20 seconds to about 10 minutes and more preferably from about 30 seconds to about 3 minutes.

The temperature at which the moulded article is contacted with the colourant or additive is preferably at least about 40° C., more preferably at least about 60° C. and most preferably at least about 80° C. When the dispersal medium is water, the preferred temperature is usually from about 60° C. to about 100° C., However, higher temperatures can be used if the contacting of the moulded article with the colourant or additive is conducted in a pressurized vessel and this may be desirable to effect quicker and/or deeper colouring or additive-imparted functionality of the moulded article.

Injection moulding of polyethylene terephthalate and other polyester moulding compositions is typically carried out using an injection moulding machine and a maximum barrel temperature in the range of from about 260°C. to about 285° C. or more, for example, up to about 310° C. The dwell time at this maximum temperature is typically in the range of about from 15 seconds to about 5 minutes or more, preferably from about 30 seconds to about 2 minutes. When producing a coloured preform or moulded article it has hitherto been desirable to select a colourant additive composition which will withstand these conditions. Somewhat lower temperatures in excess of about 100° C. up to about 170° C. or more are generally used in the blow moulding step to produce a bottle from a polyester preform. With the process of the invention, it is necessary when the moulded article is a preform only that the colourant or additive be able to withstand these less vigorous conditions. In the process of the invention when the moulded article is a blown bottle or other package it is not even necessary for the colourant or additive to be able to withstand these less robust conditions since the moulded article is coloured or provided with a functional additive only after the moulding and blowing stages. It is a recognised phenomenon within the industry that use of extended dwell times at elevated temperatures, particularly during the injection moulding step used to make a polyethylene terephthalate bottle preform, but also possible during the subsequent blow moulding step, may tend to result in an inferior colouration of the preform or blow moulded bottle. Therefore much effort has been invested in finding colourant additives which have good stability and colouring properties at these temperatures. The process of the invention provides an alternative means for colouring moulded articles which avoids these problems.

The invention further provides a convenient means for assessing the crystallinity of a moulded article. In crystalline areas a colourant is less effectively bound to the thermoplastic material because of denser packing of the polymer chain in the region of crystallinity. Accordingly the invention provides a means for assessing the crystallinity of a moulded thermoplastic article comprising contacting the thermoplastic moulded article with one or more colourants having a chemical affinity for the thermoplastic material of the moulded article for a period of time and under conditions effective to cause at least a portion of the one or more colourants to bind to the moulded article, and identifying one or more areas of crystallinity in the moulded article by subsequent inspection.

The invention further provides a method of making a blow moulded bottle from a polyester moulding composition which comprises:
i. providing a polyester moulding composition;
ii. heating the polyester moulding composition;
iii. extruding the hot polyester moulding composition so as to form a bottle preform;
iv. contacting the bottle preform with a colourant having a chemical affinity for the polyester for a period of time and under conditions effective to cause binding of the colourant to the polyester; and
v. blow moulding the bottle preform at a blow moulding temperature so
   as to form a coloured bottle.

Also provided in accordance with the invention is a method of making a blow moulded bottle from a polyester moulding composition which comprises:
a. providing a polyester moulding composition;
b. heating the polyester moulding composition;
c. extruding the hot polyester moulding composition so as to form a bottle preform;
d. blow moulding the bottle preform at a blow moulding temperature so as to form a bottle;
e. contacting the bottle with a colourant having chemical affinity for the polyester for a period of time and under conditions effective to cause binding of the colourant with the polyester.

The invention further provides a method of making a blow moulded bottle from a polyester moulding composition which comprises:
I. providing a polyester moulding composition;
II. heating the polyester moulding composition;
III. extruding the hot polyester moulding composition so as to form a bottle preform;
IV. contacting the bottle preform with an additive having a chemical affinity for the polyester for a period of time and under conditions effective to cause binding of the additive colourant to the polyester; and
V. blow moulding the bottle preform at a blow moulding temperature so as to form a bottle with a desirable functionality attributable to the bound additive.

Also provided in accordance with the invention is a method of making a blow moulded bottle from a polyester moulding composition which comprises:
A. providing a polyester moulding composition;
B. heating the polyester moulding composition;
C. extruding the hot polyester moulding composition so as to form a bottle preform;
D. blow moulding the bottle preform at a blow moulding temperature so as to form a bottle;
E. contacting the bottle with an additive having chemical affinity for the polyester for a period of time and under conditions effective to cause binding of the additive with the polyester.

The invention further provides a moulded thermoplastic article having an inside surface and an outside surface and a colourant or additive having a chemical affinity to the material of the moulded article bound predominantly to one, but not the other of said surfaces.

### DETAILED DESCRIPTION OF THE INVENTION

Generally it will be the outside surface to which the colourant or additive is bound. The colourant or additive may also be bound below the surface as it may have migrated from the point of contact into the material of the thermoplastic moulded article.

The moulded article of the invention is preferably a container, such as a bottle, or a preform thereof.

The process of the invention may be utilised to produce a multi-layer bottle comprising a layer of nylon or ethylene/vinyl alcohol copolymer sandwiched between layers of the moulding composition.

The invention is further illustrated in the following examples in which temperatures are in ° C. and parts and percentages are by weight.

### EXAMPLE 1

A dye bath was prepared containing 5 parts of Dispersol Orange A-G™ in water at 90° C.

Eastman 9921 Polyethylene terephthalate granules which had been previously dried by heating for 4 hours at 170°C. were fed into the feed hopper of an Boy 80 injection moulding machine and extruded at about a temperature of 275° C. with a dwell time at this temperature of about 2 minutes to form a number of bottle preforms, each weighing 34.5 grams.

Each of the bottle preforms was colourless.

The bottle preforms were then partially submerged in the dye bath for a period of about 5 minutes.

On being withdrawn from the dye bath and dried it was found that each of the bottle preforms had a satisfactory colour.

### EXAMPLES 2-5

A number of dye baths were prepared as described below:

| Dye-bath | | % Dyestuff |
|---|---|---|
| No. | Dispersed Dyestuff | dispersed in water |
| 1 | ICI Dispersol Orange A-G ™ | 5 |
| 2 | ICI Dispersol Blue B-2R ™ | 6 |
| 3 | ICI Dispersol Red B-2B ™ | 3 |

Eastman 9921 Polyethylene terephthalate granules, which had been previously dried by heating for four hours at 170° C., were fed into the feed hopper of an Boy 80 injection moulding machine and extruded at a temperature of 275° C. with a dwell time at this temperature of about 2 minutes, to form a number of colourless bottle preforms each weighing 34.5 grams.

The colourless bottle preforms were then partially submerged in the dye baths described above for about 5 minutes at a temperature of 90° C. to produce examples 2 to 5 in a manner described below.

| | Example 2 | Example 3 | Example 4 | Example 5 |
|---|---|---|---|---|
| Dye-bath | 1 | 2 | 3 | 1&2 |
| No. | | | | |
| Dye | Partially | Fully | After partial | Dip bottom |
| Procedure | submerge | submerge | submerge, | half of preform |
| | perform | preform | fully | in Bath 1, remove, |
| | | | submerge | dry, and submerge |
| | | | for relatively | top half of |
| | | | short period | preform in Bath 2 |
| Visual | Orange | Uniform | Colour | Up to three colour |
| Effect | base | colour | gradient | zones depending |
| | area only | | | on depth of |
| | | | | submerge |

On being withdrawn from the dye bath and dried it was found that the Examples 2 to 5 each exhibited satisfactory colour and demonstrated the range of colour patterns possible with this technique.

### EXAMPLE 6

A dye bath was prepared containing 5% of ICI Dispersol Orange A-G™ in water at 90° C.

Eastman 9921 Polyethylene terephthalate granules, which had been previously dried by heating for four hours at 170° C. together with 0.8% (on the weight of Polyethylene terephthalate) Premier Silver-11 281-019-11 (ColorMatrix), were fed into the feed hopper of an Boy 80 injection moulding machine and extruded at a temperature of 275° C. with a dwell time at this temperature of about 2 minutes, to form a number of bottle preforms exhibiting a metallic Silver appearance, each weighing 34.5 grams.

The bottle preforms were then partially submerged in the dye bath for a period of about 5 minutes.

On being withdrawn from the dye bath and dried it was found that the bottle preforms exhibited a satisfactory bicolour effect.

Thus, although there have been described particular embodiments of the present invention of a new and useful Moulded Thermoplastic Articles And Process To Make Them it is not intended that such references be construed as limitations upon the scope of this invention except as set forth in the following claims.

What is claimed is:

1. A process for manufacturing a coloured polyethylene terephthalate container or container preform comprising providing a moulded polyethylene terephthalate container or container preform, providing a colouration zone containing as a solution or dispersion in a liquid medium one or more colourants having a chemical affinity for polyethylene terephthalate, and in the colouration zone contacting the container or container preform with the one or more colourants in the liquid medium for a period of time and under conditions effective to cause at least a portion of the one or more colourants to migrate from the liquid medium and bind to the polyethylene terephthalate of the container or container preform.

2. A process according to claim 1 which comprises providing a polyethylene terephthalate moulding composition and subjecting said polyethylene terephthalate moulding composition to a moulding step thereby to form the container or container preform.

3. A process according to claim 1 wherein the one or more colourants comprises a disperse dye.

4. A process for manufacturing a polyethylene terephthalate container or container preform having additive-imparted functionality comprising providing a moulded polyethylene terephthalate article, providing an additive impartation zone containing as a solution or dispersion in a liquid medium one or more additives having a chemical affinity for polyethylene terephthalate, and in the additive impartation zone contacting the container or container preform with the one or more additives in the liquid medium for a period of time and under conditions effective to cause at least a portion of the one or more additives to migrate from the liquid medium and bind to the container or container preform.

5. A process according to claim 4 wherein the one or more additives is selected from the group comprising UV filters, oxygen absorbers, antimicrobial agents, antioxidants, light stabilizers, optical brighteners, processing stabilizers, flame retardants and mixtures of two or more thereof.

6. A process according to claim 1 wherein the effective conditions comprise a temperature of at least about 40° C.

7. A process according to claim 6 wherein the effective conditions comprise a temperature of at least about 60° C.

8. A process according to claim 1 wherein the container or container preform is a bottle or bottle preform.
